(19) United States
(12) Patent Application Publication
(10) Pub. No.: US 2023/0150420 A1
(43) Pub. Date: May 18, 2023

(54) DRAWING APPARATUS FOR VEHICLE

(71) Applicant: TOYOTA JIDOSHA KABUSHIKI KAISHA, Aichi-ken (JP)

(72) Inventors: Fumihiko MOURI, Owariasahi-shi (JP); Ken WATANABE, Toyota-shi (JP)

(21) Appl. No.: 17/985,905

(22) Filed: Nov. 14, 2022

(30) Foreign Application Priority Data
Nov. 15, 2021 (JP) 2021-185984

(51) Int. Cl. B60Q 1/22; B60Q 1/34

(52) U.S. Cl. CPC B60Q 1/22; B60Q 1/346; B60Q 2400/50

(57) ABSTRACT

A drawing apparatus for a vehicle is mounted to a vehicle and draws at least one of plural drawing patterns on a road surface in an advancing direction of the vehicle using light. The drawing apparatus for a vehicle has: a storage unit that stores the plural drawing patterns; a communication unit that receives update information on at least one of the plural drawing patterns; and a processor that updates a storage content of the storage unit by using the received update information.

### CROSS REFERENCE TO RELATED APPLICATION

This application claims priority to Japanese Patent Application No. 2021-185984 filed on Nov. 15, 2021, which is incorporated herein by reference in its entirety including the specification, claims, drawings, and abstract.

### TECHNICAL FIELD

The present disclosure relates to a drawing apparatus for a vehicle, the drawing apparatus being mounted to a vehicle and drawing a specified drawing pattern on a road surface in an advancing direction of a vehicle, using light.

### BACKGROUND

Various proposals have been made for an apparatus that assists vehicle travel, and various proposals have been made for an apparatus that draws a specified drawing pattern on a road surface (see PATENT LITERATURE 1).

The apparatus disclosed in PATENT LITERATURE 1 can clearly display, on the road surface, an image according to an inter-vehicular distance from a preceding vehicle.

### CITATION LIST

PATENT LITERATURE 1: JP 2019-119344 A

### SUMMARY

Here, in PATENT LITERATURE 1, the basis of the apparatus is to project a fixed pattern recorded in memory, and a projection distance is changed by changing a curvature of a mirror. Accordingly, in the case where the drawing pattern is changed, the memory has to be rewritten, and a recording medium has to be updated or replaced. For this reason, the vehicle has to be taken into a vehicle maintenance shop to change the drawing pattern.

A drawing apparatus for a vehicle according to the present disclosure is a drawing apparatus for a vehicle that is mounted to a vehicle and draws at least one of plural drawing patterns on a road surface in an advancing direction of the vehicle, using light, and has: a storage unit that stores the plural drawing patterns; a communication unit that receives update information on at least one of the plural drawing patterns; and a processor that updates a storage content of the storage unit by using the received update information.

The processor can select whether to update the storage content of the storage unit according to an update pattern included in the update information.

The plural drawing patterns stored in the storage unit include a default drawing pattern and the update pattern.

The update patterns include an automatic update pattern and a selective update pattern, the processor automatically receives the automatic update pattern and updates the storage content of the storage unit when the automatic update pattern is sent, and the processor shows a selection screen, receives the selective update pattern upon a user's request, and updates the storage content of the storage unit when the selective update pattern is sent.

The processor can select a drawing pattern to be used from the plural drawing patterns that are stored in the storage unit.

According to the present disclosure, the drawing pattern can be updated according to the received update information. Therefore, even in a case where the drawing pattern is changed in response to revision of a law or the like, there is no need to bring the vehicle to a vehicle maintenance shop for change of the stored drawing pattern.

### BRIEF DESCRIPTION OF DRAWINGS

Embodiment(s) of the present disclosure will be described based on the following figures, wherein:

FIG. 1 is a block diagram illustrating a configuration of a drawing apparatus 10 for a vehicle according to an embodiment;

FIG. 2 is a view illustrating an example of a notification display (a direction display) on a road surface when a vehicle changes course to the left;

FIG. 3 is a view illustrating an example of a notification display (a start display) on the road surface when the vehicle starts forward;

FIG. 4 is a flowchart illustrating processing at the time of receiving update information;

FIG. 5 is a view illustrating another example of the direction display to the left;

FIG. 6A illustrate an example of the start display at the time when the vehicle starts in reverse,

FIG. 6B illustrate an example of the start display at the time when the vehicle starts in reverse,

FIG. 7A illustrate a display situation of the start display at an intersection; and

FIG. 7B illustrate a display situation of the start display at an intersection.

### DESCRIPTION OF EMBODIMENTS

A description will hereinafter be given on an embodiment of the present disclosure with reference to the drawings. The present disclosure is not limited to the embodiment described herein.

### Overall Configuration

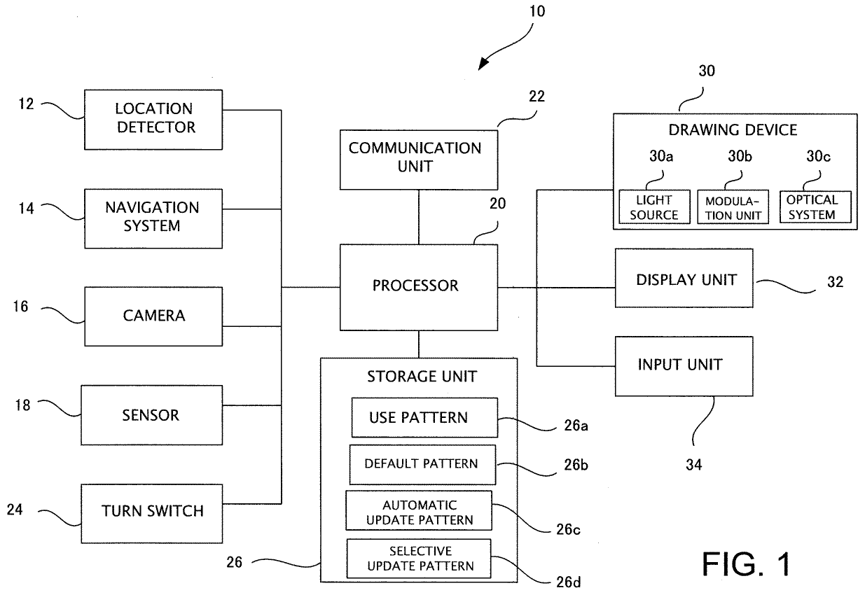

FIG. 1 is a block diagram illustrating a configuration of a drawing apparatus 10 for a vehicle according to the embodiment.

The drawing apparatus 10 for a vehicle is mounted to a vehicle, and draws a course display in an advancing direction on a road surface around the vehicle.

A location detector 12 includes a global navigation satellite system (GNSS) such as the Global Positioning System (GPS) and detects a location of the vehicle in which it is mounted. The location detector 12 may acquire location information from communications equipment (for example, a beacon) provided at an intersection or the like, information from a traffic management center, or another vehicle, and the like, by communication, or may refer to a travel situation of the vehicle and a video image of the surroundings.

A navigation system 14 has a map database and assists vehicle travel by showing a map on a display, showing the location of the vehicle on a map display, showing a route that is acquired by a route search to a destination, and changing the route by acquiring traffic jam information.

A camera 16 acquires the video image of the surroundings of the vehicle in order to assist the vehicle travel. The camera 16 acquires a video signal using an imaging element such as a charge-coupled device (CCD) or a complementary MOS (CMOS).

A sensor 18 detects a vehicle state and includes a vehicle speed sensor, a brake sensor, an accelerator sensor, a steering amount sensor, a shift position sensor, a parking brake sensor, and the like. The vehicle speed sensor detects a vehicle speed from a rotation speed of a drive shaft, the brake sensor detects a depression amount of a brake pedal, the accelerator sensor detects a depression amount of an accelerator pedal, the shift position sensor detects a shift position (for example, a shift lever position such as park, reverse, drive, or low) that is based on an operation of a shift lever, and the parking brake sensor detects an operation state of a parking brake (may also be referred to as a side brake).

A turn switch 24 generates a right/left turn signal when operated by a driver. A corresponding turn lamp is lit and made to blink by the signal from this turn switch 24. That is, a right turn lamp is made to blink when changing course to the right, and a left turn lamp is made to blink when changing course to the left.

The signals from the location detector 12, the navigation system 14, the camera 16, the sensor 18, and the turn switch 24 are supplied to a processor 20. The processor 20 is constructed of a computer having: an arithmetic section such as a CPU; a storage section such as RAM and ROM; and the like, and executes various programs stored in the storage section to execute various types of data processing.

In this example, the processor 20 detects a start of the vehicle on the basis of detection results by the brake sensor, the parking brake sensor, and the shift position sensor, to control a notification display, and draws the notification display in a specified shape on the road surface in response to the signal from the turn switch 24.

A communication unit 22 is connected to the processor 20. The communication unit 22 performs various types of wireless communication with external communications equipment. Required data for the navigation system 14 and the location detector 12, the video image of the surrounding environment, information on a travel situation of the other vehicle, and the like, can be acquired via the communication unit 22.

A storage unit 26 is connected to the processor 20 and stores various programs and data. Here, this storage unit 26 stores drawing patterns of notification display shapes to be drawn by a drawing device 30, which will be described below, on the road surface. There are plural types of drawing patterns, and at least one currently-used drawing patterns is stored in a use pattern storage unit 26a, at least one of drawing pattern that is stored in advance is stored in a default pattern storage unit 26b, at least one of drawing pattern that is automatically updated is stored in an automatic update pattern storage unit 26c, and at least one of drawing pattern that is updated upon a request through selection by a user is stored in a selective update pattern storage unit 26d.

The drawing device 30 is connected to the processor 20. This drawing device 30 draws the notification display in the specified shape, which indicates the advancing direction, on the road surface, and is constructed of a projector that projects an image by using light from a LED or the like. In addition, the drawing device 30 is supplied with pattern data that is stored in the use pattern storage unit 26a of the above-described storage unit 26, changes this pattern data to a drawing signal, and draws the corresponding notification display. The drawing pattern used in each situation is determined in advance, and each of the drawing patterns stored in the use pattern storage unit 26a is linked with the notification display that is shown according to the situation. Thus, according to the situation, the processor 20 reads the corresponding use pattern from the use pattern storage unit 26a, and supplies the corresponding use pattern to the drawing device 30 for drawing.

Any of various devices can be adopted as the drawing device 30. For example, a drawing device 30 that has a light source 30a, a modulation unit 30b, and an optical system 30c can be adopted, in which light from the light source 30a is modulated by the modulation unit 30b and the modulated light is projected onto a specified position on the road surface by the optical system 30c. The light source 30a can be constructed of the LED, the modulation unit 30b can be constructed of a reflective digital light deflector (DMD: Digital Mirror Device), and the optical system 30c can be constructed of plural lenses, plural mirrors, and the like. A transmissive liquid-crystal projector or the like can also be adopted as the modulation unit 30b. The drawing device 30 is exemplified in PATENT LITERATURE 1.

The drawing device 30 is supplied with the drawing pattern, which is stored in the storage unit 26, from the processor 20, controls the modulation unit 30b, and can thereby draw the notification display in the desired drawing pattern.

For example, the drawing device 30 projects the notification display, which indicates the start of the vehicle, onto the road surface at the start. In a state where the signal in the right direction is output from the turn switch 24 and the turn lamp for the right direction blinks, the drawing device 30 projects, onto the road surface, a display including an arrow indicating that the vehicle travels to the right (or to the left) from a position ahead, an arrow indicating an expected travel path, and the like.

Furthermore, a display unit 32 and an input unit 34 are connected to the processor 20. A flat display such as a liquid-crystal display (LCD) or an organic EL display can be adopted as the display unit 32, and a touchscreen or the like that cooperates with the display unit 32 can be used as the input unit 34. Furthermore, a mobile terminal such as a smartphone can also be used as the input unit 34 and the display unit 32. In this case, the mobile terminal is connected to the processor 20 by the communication using the communication unit 22.

### Direction Display

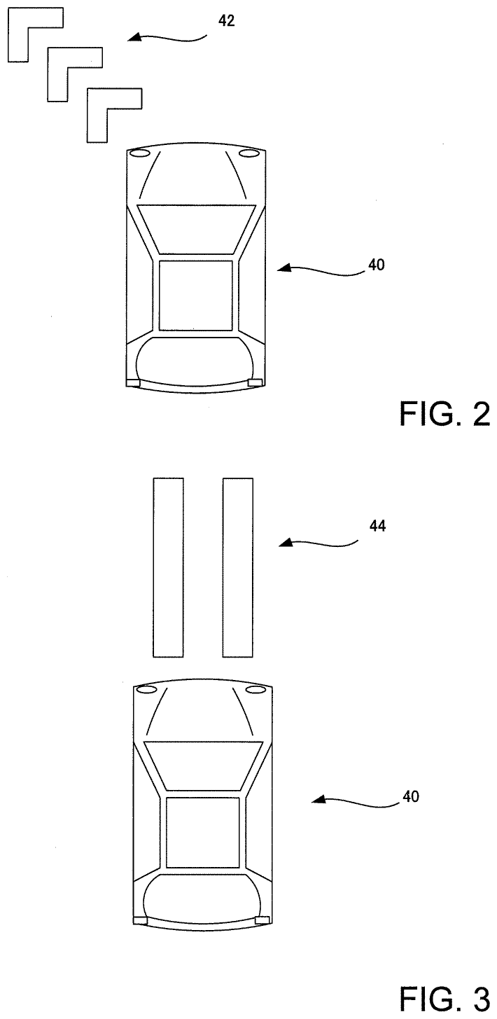

FIG. 2 is a view illustrating an example of the notification display (referred to as a direction display) on the road surface at the time when the turn switch 24 is turned on in order to change the course of the vehicle to the left (for example, make a left turn) in the case where the vehicle changes course to the left. As described above, the turn lamp blinks when the turn switch 24 is turned on.

As illustrated in FIG. 2, a direction display 42 is drawn on the road surface and is for the advancing direction that is indicated by arranging three inverted V-shaped marks in a 45-degree direction to the left in front of a vehicle 40. In this way, the surrounding vehicle, pedestrians, and the like can acknowledge the advancing direction of the vehicle 40 by seeing this direction display 42. At this time, the turn switch 24 of the vehicle 40 is operated normally. In a case of changing course to the right (for example, making a right turn), the right-left direction only needs to be reversed from the case of the left direction.

As the notification display (the direction display) in the case of changing course to the right or the left, various displays such as a display of the right turn or a display of an arrow at 45 degrees to the right can also be adopted.

The direction display may be provided in response to steering. That is, the processor 20 can predict the course of the vehicle 40 by using information from the location detector 12, the navigation system 14, the camera 16, the sensor 18, and the like. Thus, the direction display can also be controlled according to this prediction. In particular, when corresponding steering is initiated at a point where the course change to the left or the right is predicted, the direction display can be provided on the basis of a determination that the course change as predicted is made at that time point.

### Start Display

FIG. 3 is a view illustrating an example of a start display 44 that is a notification display on the road surface at the time when the vehicle starts forward. As illustrated in FIG. 3, upon the start, the start display 44 that includes two straight lines (bold lines) in front of the vehicle 40 is drawn on the road surface. In this way, it is possible to notify that the vehicle 40 plans to travel forward. In the case of reversing, a similar display only needs to be drawn behind the vehicle 40.

Here, description will be given on the start time. First, during parking at a parking lot or the like, a power switch of the vehicle 40 is off, and a drive source such as an engine or a motor is in an off state. In addition, the shift position is park, and the parking brake is on. In the case of starting, a series of the following operations is performed. First, the power switch is turned on, thereafter a foot brake is turned on, and the shift position is moved to drive. In this way, drive power from the drive source such as the engine or the motor can be transmitted to wheels, and the vehicle 40 is in a state capable of starting when the foot brake is released. A time when the vehicle 40 is brought into this start-enabled state may be included in the scope of the start time.

There is often a case where, when the vehicle is waiting at a traffic light or is temporarily stopped on a shoulder of the road, the vehicle is stopped with the power switch remaining on. In this case, the brake is on while the shift position remains in drive. In this state, the vehicle 40 starts when the brake is turned off. Thus, this state may be included in the scope of the start time.

At this start time, the notification display in FIG. 3 is drawn on the road surface. Then, the notification display is maintained until a time after the vehicle 40 starts moving and actually starts traveling. Thereafter, the notification display is turned off when the vehicle 40 moves several meters, for example.

There is often a case where the start display cannot be drawn on the road surface due to presence of a preceding vehicle when the vehicle 40 is stopped and waiting at the traffic light at an intersection. In such a case, the start display may not be provided.

### Update of Drawing Pattern

The drawing apparatus for a vehicle according to this embodiment can draw the direction display, the start display, and the like on the road surface. Here, there is also a case where it is desired to change the drawing pattern to be used. For example, in the case where it is attempted to draw a drawing pattern such as a traffic sign that is defined by a law and the drawing pattern is changed by the law, the drawing pattern to be used also has to be changed. In addition, it is convenient when plural drawing patterns are available for the direction display and the start display, and the drawing pattern can be selected according to the user's preference.

Accordingly, in this embodiment, the drawing pattern for the notification display is supplied from an external center or the like by over-the-air (OTA) communication by the communication unit 22, and storage contents of the storage unit 26 are updated. In this way, the drawing pattern used in the drawing device 30 can be changed.

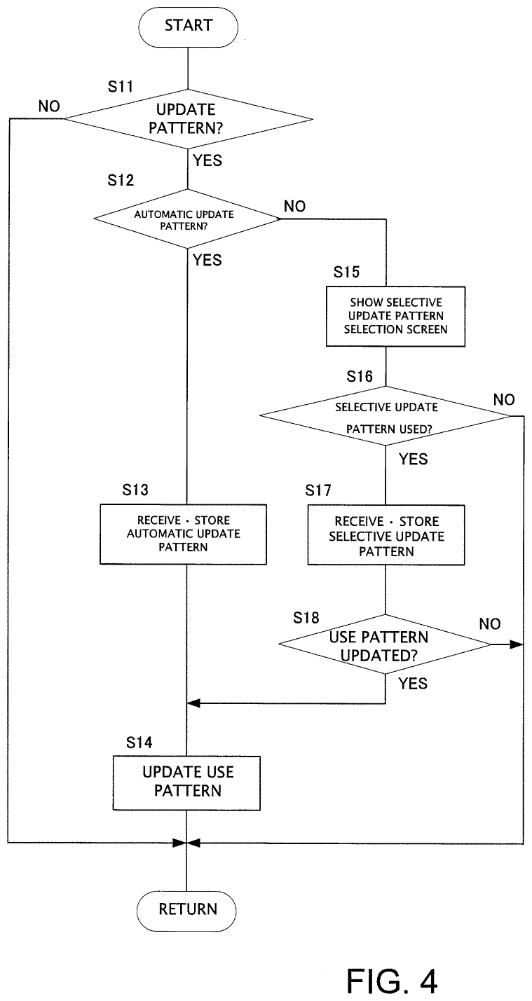

FIG. 4 is a flowchart illustrating processing at the time of receiving update information. The processor 20 determines whether an update pattern of the notification display can be received according to the information from the communication unit 22 (S11). If a determination result in S11 is NO, the processing is terminated.

If a determine result is YES in step S11, it is determined whether the drawing pattern to be updated is an automatic update pattern on the basis of the received update information (S12). If YES is determined, the automatic update pattern is received, and is stored in the automatic update pattern storage unit 26c (S13). The automatic update pattern is the drawing pattern, the update of which, such as an update based on the law, is strongly recommended, and is automatically received when becoming available.

Then, the received automatic update pattern is also stored in the use pattern storage unit 26a (S14). Thus, the automatic update pattern is automatically updated at the time of reception, and is then used.

If NO is determined in S12, the provided update pattern is a selective update pattern, and a selection screen for selecting whether to receive the selective update pattern is shown in the display unit 32 (S15). On this selection screen, a price for receiving and using the selective update pattern may be shown, or an image of the selective update pattern, and the like, may be shown.

Then, the processing waits for input by the input unit 34, and it is determined whether the user receives the selective update pattern (S16). If YES is determined in S16, that is, if the user has performed the input to request the reception, the selective update pattern is received, and the received selective update pattern is stored in the selective update pattern storage unit 26d of the storage unit 26 (S17). In the case where the plural selective update patterns are available, the drawing pattern to be received can be selected, and a plurality thereof may be selected. Then, an inquiry as to whether to set the received selective update pattern as the use pattern is made, and the user's input is determined (S18). If YES is determined in this S18, the received selective update pattern is stored in the use pattern storage unit 26a for the update (S14), and the processing is terminated. Consequently, the received selective update pattern starts being used. If NO is determined in S18, the use pattern is not updated, and the processing is terminated.

As described above, according to this embodiment, the drawing pattern for the notification display is updated through the OTA on the basis of the information on the sent update pattern. Thus, even in a case where the drawing pattern is changed in response to revision of the law or the like, the drawing pattern can be automatically changed, and there is no need to bring the vehicle to a vehicle maintenance shop for the update of the drawing pattern.

In addition, in the case of the selective update pattern, an inquiry as to whether to receive the selective update pattern (download data) is made when the selective update pattern becomes available and can be received. When the selective update pattern is unnecessary, the selective update pattern is not received. Thus, it is possible to prevent addition of the unnecessary drawing pattern, which confuses the user when the user selects the drawing pattern. In addition, when a price is set for the drawing pattern, unnecessary expense can be avoided.

In the case where plural candidates are available, the user can select any thereof on the basis of their preference. That is, when the plural drawing patterns are stored for a single situation, the user's selection range based on their preference is expanded.

As described above, since the drawing pattern that is not set as the use pattern is also stored in the storage unit 26, it is possible to invoke such a drawing pattern when necessary to update the use pattern. For example, the drawing patterns that can be shown according to a condition are shown upon request, and the user can select the use pattern from those shown patterns. In this way, the use pattern can be changed at any time. Furthermore, in this embodiment, since the default patterns are stored in the default pattern storage unit 26b of the storage unit 26, it is not essential to download the drawing pattern.

### Display Examples

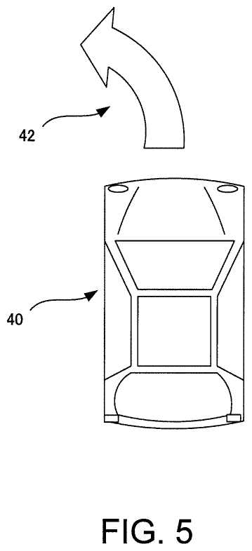

FIG. 5 is a view illustrating another example of the direction display 42 to the left. As illustrated in FIG. 5, an arrow that turns to the left can be adopted.

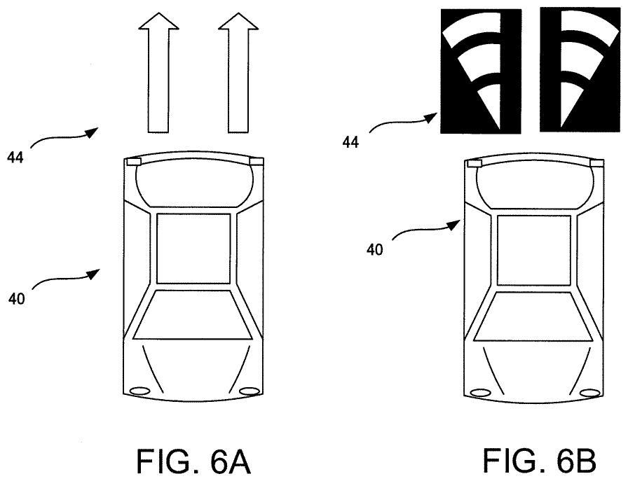

FIGS. 6A and 6B illustrate examples of the start display 44 at the time of starting the vehicle in reverse. In FIG. 6A, similar to the forward start, two bold straight lines are shown. However, the two bold straight lines are arrows. In the right drawing, the start display 44 is in a shape that expands in fan-like fashion to the rear. That is, the two patterns, each of which extends rearward, expand outward to the rear, and each of the two patterns is divided into three sections to the rear. In FIG. 6B, the monochrome pattern is schematically illustrated.

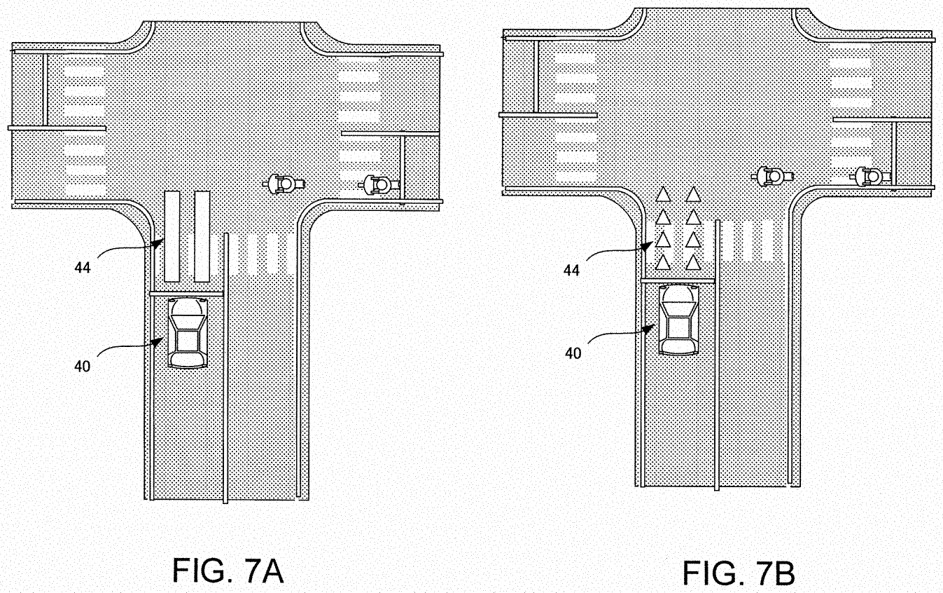

FIGS. 7A and 7B illustrate display situations of the start display 44 at the intersection. When the vehicle 40, which is stopped in front of the intersection, makes the start display when starting, a bicycle that is about to pass the intersection can effectively be notified of the start. In FIG. 7A, two straight lines are adopted. In FIG. 7B, a top view, two straight lines, each of which is formed by aligning triangles, are adopted.

1. A drawing apparatus for a vehicle that is mounted to a vehicle and draws at least one of plural drawing patterns on a road surface in an advancing direction of the vehicle using light, the drawing apparatus for a vehicle comprising:
a storage unit that stores the plural drawing patterns;
a communication unit that receives update information on at least one of the plural drawing patterns; and
a processor that updates a storage content of the storage unit by using the received update information.

2. The drawing apparatus for a vehicle according to claim 1, wherein
the processor can select whether to update the storage content of the storage unit according to an update pattern included in the update information.

3. The drawing apparatus for a vehicle according to claim 2, wherein
the plural drawing patterns stored in the storage unit include a default drawing pattern and the update pattern.

4. The drawing apparatus for a vehicle according to claim 2, wherein
the update patterns include an automatic update pattern and a selective update pattern,
when the automatic update pattern is sent, the processor automatically receives the automatic update pattern and updates the storage content of the storage unit, and
when the selective update pattern is sent, the processor shows a selection screen, receives the selective update pattern upon a user's request, and updates the storage content of the storage unit.

5. The drawing apparatus for a vehicle according to claim 3, wherein
the update patterns include an automatic update pattern and a selective update pattern,
when the automatic update pattern is sent, the processor automatically receives the automatic update pattern and updates the storage content of the storage unit, and
when the selective update pattern is sent, the processor shows a selection screen, receives the selective update pattern upon a user's request, and updates the storage content of the storage unit.

6. The drawing apparatus for a vehicle according to claim 1, wherein
the processor can select a drawing pattern to be used from the plural drawing patterns that are stored in the storage unit.
